(19) United States
(12) Patent Application Publication
(10) Pub. No.: US 2024/0292941 A1
(43) Pub. Date: Sep. 5, 2024

(54) APPLICATOR FOR A COSMETIC PRODUCT, IN PARTICULAR MASCARA, ASSOCIATED APPLICATOR ASSEMBLY AND METHOD FOR MANUFACTURING SUCH AN APPLICATOR

(71) Applicant: ALBEA SERVICES, Gennevilliers (FR)

(72) Inventor: Yann CRAPET, Gennevilliers (FR)

(73) Assignee: ALBEA SERVICES, Gennevilliers (FR)

(21) Appl. No.: 18/572,721

(22) PCT Filed: Dec. 9, 2021
(86) PCT No.: PCT/EP2021/084962

§ 371 Date: Dec. 20, 2023

(30) Foreign Application Priority Data
Jun. 24, 2021 (FR) FR2106799

(51) Int. Cl. A46B 9/02; A45D 40/26

(52) U.S. Cl. CPC A46B 9/021; A45D 40/267; A46B 2200/1053

(57) ABSTRACT

The invention relates to an applicator for a cosmetic product comprising at least two arms extending along a main longitudinal axis of extension, referred to as the main axis (X), from a proximal end extended by a sleeve towards a free distal end opposite to the proximal end, at least one of the arms comprises at least two portions (A, B, C), at least one of the portions (A, B, C) presenting a longitudinally winding of a different direction.

### CROSS-REFERENCE TO RELATED APPLICATIONS

This application is the National Stage of International Application No. PCT/EP2021/084962, filed Dec. 9, 2021, which claims priority to French Application No. 2106799, filed Jun. 24, 2021, and the contents of which are incorporated by reference.

### TECHNICAL FIELD OF THE INVENTION

The invention relates to an applicator for cosmetic product, in particular mascara, and an associated applicator assembly. The invention further relates to a method for manufacturing such an applicator.

### TECHNICAL BACKGROUND

The mascara applicators can be obtained from fibrous elements held between the longitudinal parts of a twisted metallic broach; they are then commonly referred to as “twisted brushes”. The ends of the fibrous elements usually form envelopes along an axis of longitudinal extension of the brush. The twisted brushes, has, by their manufacturing mode, an envelope with cylindrical shape that offers few possibilities in terms of make-up effects. Many solutions have already been proposed to give various shapes to twisted brushes.

The mascara applicators can also be obtained by injection moulding of plastic material, they are then commonly referred to as “plastic brushes”. Thus, the plastic brushes can have original shapes in order to offer particular make-up effects.

For example, there are mascara applicators comprising arms that wind helically around the central axis.

However, depending on the pitch of the helix, these mascara applicators are designed for combing rather than lash volume, and vice versa. In addition, the pitch of the helix varies the flexibility of the applicator, particularly along the main axis, and the comfort of use. This makes it difficult to find a compromise between the load distribution and application, while retaining the flexibility required for a pleasant make-up for the user.

There is therefore a need to improve applicators for cosmetic products, in particular to obtain applicators with a good restitution of the stored cosmetic product while being easy and comfortable to use.

### SUMMARY OF THE INVENTION

The invention relates to an applicator for a cosmetic product comprising at least two arms extending along a main longitudinal axis of extension, referred to as the main axis, from a proximal end extended by a sleeve towards a free distal end opposite the proximal end, at least one of the arms comprises at least two portions, at least one portion presenting a longitudinally winding of a different direction.

In other words, the applicator comprises application areas formed by the arms which alternate with storage areas formed by the spaces created between the arms. The storage areas allow cosmetic products to be stored and then restituted when the product is applied. The user does not need to refill the product and can apply make-up in a single gesture.

As the application progresses, there is an alternation between restitution of the cosmetic product and application, thus avoiding an excess of cosmetic product and improving application.

In addition, the change in direction of the winding enables the storage areas and application areas to alternate longitudinally, i.e., along the main axis, and also angularly, i.e., around the main axis.

In other words, the storage areas and the application areas shift as the applicator rotates.

As a result, the user gains in ease and comfort of use. Indeed, whatever the direction of rotation and/or the gesture of the applicator, restitution and application alternate identically.

According to various embodiments, which may be taken together or separately:
the cosmetic product is mascara,
the applicator comprises protuberances extending from at least one of the arms,
the applicator has no central core,
the applicator comprises at least three arms,
each of the arms comprises at least two portions presenting a longitudinally winding of different direction,
said at least one of the arms comprises at least three portions, each portion presenting a longitudinally winding of a different direction from the adjacent portion,
the arms are narrow,
the arms have a constant cross-section,
the arms are of variable cross-section,
the arms have a flat internal surface directed towards the main axis,
the arms have a non-circular cross-section,
the arms have a cross-section with a flat edge,
the flat edge of the cross-section of the arms is oriented towards the inside of the applicator,
the arms have a cross-section in general shape of a portion of a circle,
openings are defined between each of the arms,
the arms alternate angularly with openings defined between each of the arms,
the openings extend longitudinally,
the openings extend longitudinally from the proximal end of the applicator towards the distal end of the applicator,
the longitudinal rows follow the winding of the arm on which they are located,
the winding of the arm around the main axis has a constant pitch between the proximal end and the free distal end,
the winding of the arm around the main axis has a variable pitch between the proximal end and the free distal end,
each portion has a different pitch,
the pitch variation is identical for each of the arms,
the arms may comprise at least one straight portion,
said at least two arms define a cavity forming a reservoir volume,
the cavity is of cylindrical general shape,
the cavity has a shape of revolution about the main axis,
the cavity does not have a shape of revolution about the main axis,
the flat edge of the cross-section of the arms is oriented towards the cavity,
said at least two arms wind parallel to each other around the main axis,
said at least two arms meet at the level of the free distal end,
said at least two arms are linked at the level of the free distal end,
each of said at least two arms comprises at least one longitudinal row of protuberances extending radially outwards from the arm,
each of said at least two arms comprises three longitudinal rows of protuberances extending radially outwards from the arm,
the protuberances are arranged in radial rows perpendicular to the main axis,
the protuberances comprise an planar upper face directed towards the distal end of the applicator,
the protuberances comprise a planar lower face directed towards the proximal end,
the upper face and the lower face extending from a base connected to the arm to an opposite free end, the free end being circular.
the circular free end of the protuberances is angularly offset with respect to the base.
said at least two arms are made of plastic or synthetic material.
the applicator has an envelope formed by the distal end of the protuberances, said envelope having a cylindrical profile with a circular cross-section.
the applicator is a monolithic piece,
the applicator is a piece obtained without assembly,
the applicator is a piece obtained by additive manufacturing.

The invention also relates to an applicator assembly for a cosmetic product, comprising:
a container comprising a body forming a reservoir intended to contain the cosmetic product, and
an applicator of cosmetic product as described above, adapted to be attached to the container, so that the applicator is housed inside the reservoir.
The invention finally relates to a method for manufacturing an applicator for a cosmetic product, in particular mascara, as described above.

The method comprises:
a step of elaborating a digital model of the applicator;
a step of manufacturing the applicator by means of the digital model.

### BRIEF DESCRIPTION OF THE FIGURES

Further characteristics and advantages of the invention will become apparent from the following detailed description, for the understanding of which reference is made to the attached drawings in which:

FIG. 1 is a sectional view of an example of applicator assembly according to the invention;

FIG. 2 is a perspective view of an applicator according to the invention;

FIG. 3 is a side view of the applicator of the FIG. 2;

FIG. 4 is a longitudinal section of the applicator of the FIG. 3;

FIG. 5 is a cross-sectional view A-A of the applicator of the FIG. 3

FIG. 6 is a perspective view of FIG. 5;

FIG. 7 is a perspective view of a cross-section B-B of the applicator of the FIG. 3.

### DETAILED DESCRIPTION OF THE INVENTION

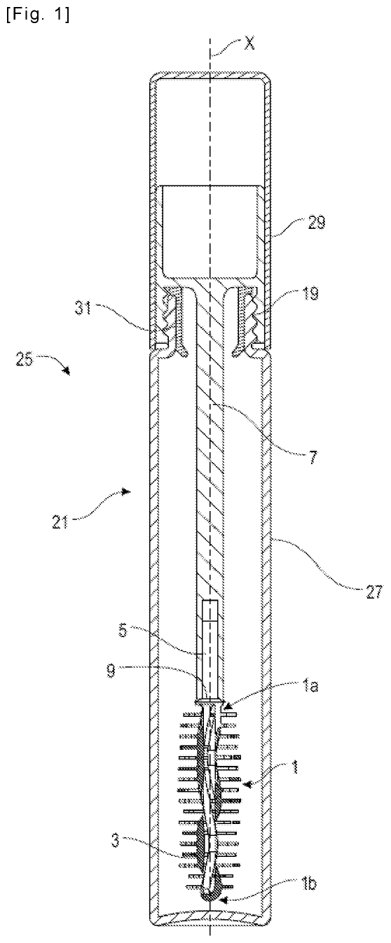

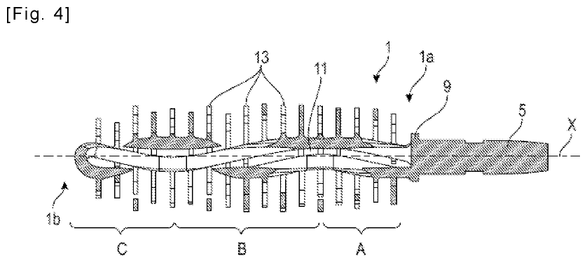

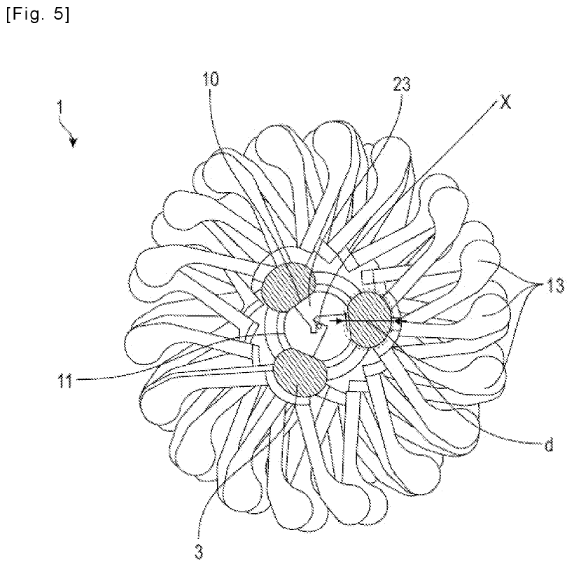

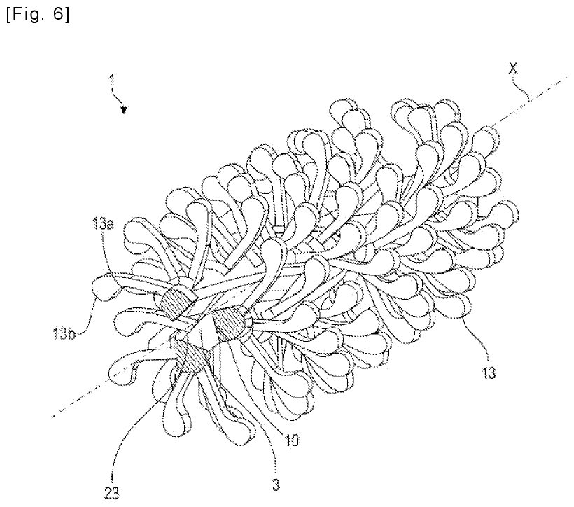

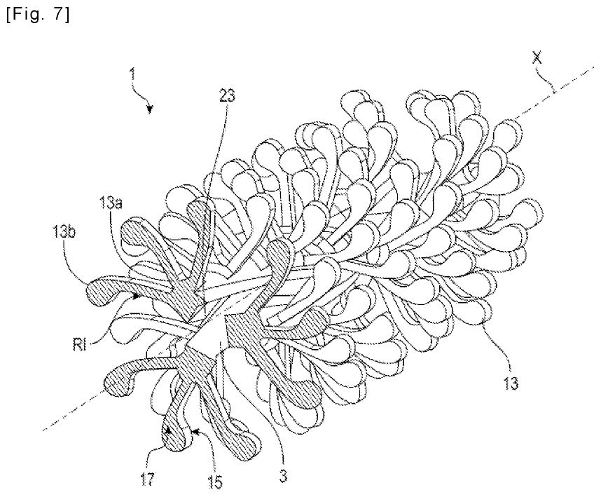

FIGS. 1 to 7 show an example of embodiment of an applicator 1 for a cosmetic product, in particular a cosmetic product to be applied to the eyelashes and eyebrows, such as mascara.

In the embodiment shown in FIGS. 1 to 7, the applicator 1 comprises three arms 3 extending along a main longitudinal axis of extension, referred to as the main axis and marked X on FIG. 1, from a proximal end 1a extended by a sleeve 5 to a free distal end 1b opposite the proximal end 1a.

Advantageously, the applicator 1 can comprise an even or odd number of arms 3.

Thus, in other embodiments not shown, the applicator 1 may comprise two arms 3, or even four arms 3, or even five arms 3, or even six arms 3.

The proximal end 1a of the applicator 1 can be fixed to a stem 7 of the applicator 1 by the sleeve 5 extending the arms 3.

At the level of the proximal end 1a, the arms 3 are connected to a stop ring 9 of the sleeve 5 and extend to the opposite end where they meet and are connected together to form the free distal end 1b of the applicator 1.

In other words, the arms 3 are stems of material which extend longitudinally along the main axis X from the proximal end 1a located towards the sleeve 5 in the direction of the opposite free distal end 1b.

The arms 3 are angularly distributed around the main axis X.

In other embodiments not shown, the arms 3 may extend along an axis inclined with respect to the sleeve 5. The arms can also have at least one convex or concave longitudinal curvature.

Preferably, the arms 3 are arranged in a regular pattern around the main axis X. In other words, the arms 3 are spaced around the main axis X with a substantially identical angular spacing.

Advantageously, this angle depends on the number of arms 3 and their distribution around the main axis X.

So, in the case of two arms 3, the arms 3 are spaced with an angular space substantially equal to 180° of angle.

In the case of three arms 3, the arms 3 are spaced with an angular spacing substantially equal to a 120° angle.

In the case of four arms 3, the arms 3 are spaced with an angular spacing substantially equal to a 90° angle.

In the case of five arms 3, the arms 3 are spaced with an angular spacing substantially equal to 72° angle.

In the case of six arms 3, the arms 3 are spaced with an angular spacing substantially equal to 60° angle.

In the illustrated embodiment, the three arms 3 are thus evenly spaced around the main axis X with an angular spacing substantially equal to 120°.

Here, the arms 3 are narrow. By narrow, it is understood to be longer than it is wide.

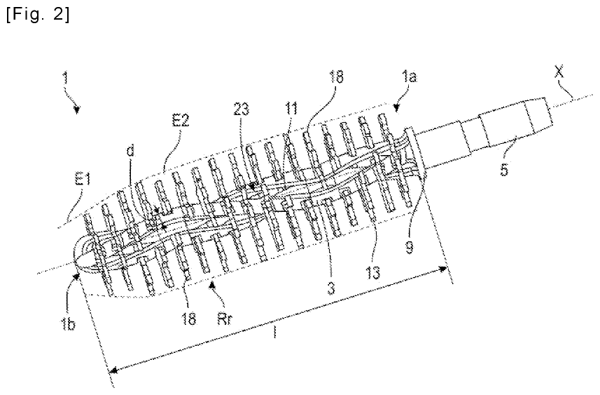

Thus, the cross-section of the arms 3 lies within a circle of diameter d less than a length I of the applicator 1. The length I is measured from the proximal end 1a of the applicator 1 to the distal end 1b of the applicator 1 as shown in FIG. 2.

Advantageously, the l/d ratio is between 5 and 40. Preferably, the l/d ratio is about 20.

In the embodiment shown here, the arms 3 have an internal surface directed towards the main axis X which is flat.

In other words, the arms 3 have a cross-section in general shape of a portion of a circle with a flat edge 10. The flat edge 10 of the cross-section of the arms 3 is oriented towards the inside of the applicator 1.

The shape and the dimensions of the cross-section are substantially constant over the entire length of the arms 3.

In other embodiments not shown, the arms 3 can be of variable cross-section, both in shape and size. The size of the arms, in particular the variation in diameter d, allows the flexibility of the applicator to be influenced, so that it can be customised.

The arms 3 thus form an applicator 1 of elongated general shape.

Advantageously, the three arms 3 alternate angularly with openings 11. In other words, the openings 11 are defined between each of the arms 3 and extend longitudinally from the proximal end 1a of the applicator 1 towards the distal end 1b.

Advantageously, the applicator 1 illustrated here further comprises a plurality of protuberances 13 extending radially outwards from the arms 3 from a base 13a connected to the arm 3 to an opposite free end 13b.

On the other hand, the sleeve 5 has no protuberances.

The protuberances 13 are came from material with the arm 3 from which they project. In other words, the arms 3 and the protuberances 13 are made in a single piece.

The protuberances 13 are arranged in longitudinal rows RI and radial rows Rr.

The longitudinal rows RI follow the winding of the arm 3 on which they are located.

The radial rows Rr are perpendicular to the main axis X.

Advantageously, in the case of arms 3 comprising protuberances 13, the arms 3 form application areas which are used to apply the cosmetic product and also to comb, for example, the eyelashes and/or eyebrows.

The arms 3 thus define application areas, which alternate angularly with storage areas formed by the openings 11 between the arms 3.

In the embodiment shown here, each of the arms 3 comprises three longitudinal rows RI of protuberances 13 extending radially outwards from the arm 3.

The protuberances 13 comprise a planar upper face 15 directed towards the distal end 1b of the applicator 1 and a planar lower face 17 directed towards the proximal end 1a. In other words, in this embodiment, the protuberances 13 are planar and extend in a plane perpendicular to the main axis X.

Moreover, advantageously, in this embodiment the free end 13b of the protuberances 13 is circular. The free circular end 13b is angularly offset with respect to the base 13a. In other words, the free end 13b of the protuberances 13 is not centred with respect to the base 13a.

This particular shape of the protuberances 13 contributes to perfect the combing and separation of the eyelashes. In particular, the offset of the free end 13b provides an additional reserve of cosmetic product to add volume and elongation to each of the eyelashes.

In the embodiment shown here, the free ends 13b of the protuberances 13 are oriented in the same rotational direction. This allows to favour one direction of application and to promote a particular make-up effect depending on the direction of application. The result is two distinct make-up effects, depending on the direction of application.

In this embodiment, the so-called distal protuberances 13, i.e., the protuberances 13 which extend close to the distal end 1b of the applicator 1, have different heights. The free distal ends 13b of the protuberances 13 thus form an ogival-shaped envelope E1.

The protuberances 13 which extend between the proximal end 1a of the applicator 1 and the distal protuberances 13 all have substantially the same height for the same row and form a substantially cylindrical general envelope E2 with a circular cross-section (see FIG. 2).

The ogival-shaped envelope facilitates the insertion and/or removal of the applicator 1 through a neck 19 of a container 21 containing the cosmetic product.

In another embodiment not shown, the distance between the base of the protuberance and the free end of the protuberances 13 may be substantially the same for all the protuberances 13 that the applicator 1 comprises. The free distal ends of the protuberances 13 then form a cylindrical envelope.

In yet another embodiment not shown, the protuberances 13 can be of different heights from one row to the next. The free distal ends of the protuberances 13 then form an envelope whose shape can vary, in particular an envelope that is at least partly substantially concave, convex or even has several vertices.

Advantageously, the applicator 1 has no central core allowing the arms 3 to define a central cavity 23 forming an additional reservoir volume for the cosmetic product. The openings 11 then allow the cosmetic product to be restituted.

In other words, the cavity 23 is delimited by the arms 3 of the applicator 1 and comprises openings 11.

In this embodiment, the cavity 23 is of cylindrical general shape with a hexagonal cross-section, the three sides of which are defined by the flat edges 10 of the cross-sections of the arms 3 and the other three sides are defined by the openings 11.

The application areas are used to apply the cosmetic product stored in the storage areas. Particularly in the case of an applicator 1 comprising protuberances 13, the application areas enable eyelashes and/or eyebrows, for example, to be combed.

In this embodiment, the three arms 3 each comprise three portions: a first portion A located towards the sleeve 5, a second central portion B and a third portion C located towards the free distal end 1b of the applicator 1.

According to the invention, at least one of the portions A, B and C presents a longitudinally winding of a different direction.

The direction of winding is defined by looking at the direction of winding of the arm portion around the main axis X from the proximal end 1a of the applicator 1 towards the distal end 1b of the applicator 1.

In this way, you can have a winding to the left or winding to the right.

Winding to the left is understood to mean winding in the clockwise direction of rotation when looking at the applicator 1 of the free distal end 1b and in the anti-clockwise direction of rotation when looking at the applicator 1 of the proximal end 1a.

Winding to the right is understood to mean anti-clockwise direction of rotation when looking at the applicator 1 of the free distal end 1b and clockwise direction of rotation when looking at the applicator 1 of the proximal end 1a.

Advantageously, at least one of the arms 3, preferably each of the arms 3, may comprise at least two portions, preferably three portions, or even four portions, or even five portions, each of the portions presenting a longitudinally winding of a different direction.

In particular, when the arms 3 comprise at least three portions A, B, C, each portion A, B, C presents a longitudinally winding of a different direction from the adjacent portion A, B, C.

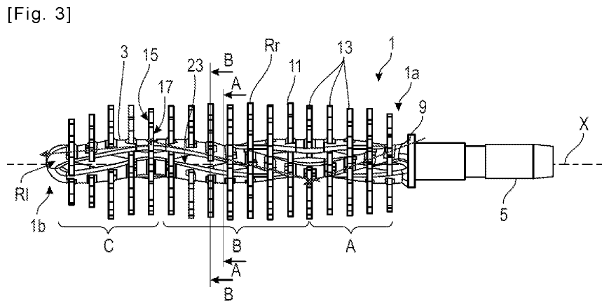

Thus, in the embodiment shown, the first portions A and the third portions C have a winding to the left and the second central portions B have a winding to the right, as shown in FIG. 3 with arrows.

Advantageously, the arms 3 extend longitudinally along the main axis X, winding parallel to each other.

Preferably, as illustrated here, the arms 3 are linked together at the level of the free distal end 1b of the applicator 1 and they are linked to the stop ring 9 of the sleeve 5 at the level of the proximal end 1a.

In another embodiment not shown, the arms 3 may comprise at least one straight portion. In other words, a portion of the arm 3 may not have winding around the main axis X. The straight portion(s) may be interposed between the portions A, B, C presenting a winding, and/or be located towards the proximal end 1a, and/or towards the distal end 1b and/or in the centre of the arm 3. The key is to have at least one area along the length of the arm 3 with a winding in at least two different directions.

The pitch of the winding of an arm 3 around the main axis X can be constant or variable between the proximal end 1a and the free distal end 1b.

For example, each portion A, B, C can have a different pitch.

The pitch variation can be identical for each of the arms 3, so that all the arms 3 of the applicator 1 extend parallel to each other.

In other embodiments not shown, the arms 3 can be linked together at a plurality of points, for example two points, or even three points, or even four points. For example, the arms 3 can be linked together at the level of the changes in direction of the winding. In other words, the applicator 1 can include connection points (or material bridges) to link the arms 3 together. The number of connection points can be a function of the number of portions A, B, C per arm 3.

The change in direction of the winding allows storage areas and application areas to alternate longitudinally, i.e., along the main axis X, but also angularly, i.e., around the main axis X.

As the application progresses, there is an alternation between the restitution of the cosmetic product and the application, thus avoiding an excess of cosmetic product and improving application.

Furthermore, in the case of an applicator 1 comprising protuberances 13, the application areas, i.e., the arms 3, allow eyelashes and/or eyebrows to be combed. The change in direction of the winding gives the impression that the height of the protuberances 13 is changing around the main axis X.

In addition, the change in direction of the winding, in the case of an applicator 1 comprising protuberances 13, enables the formation of grooves 18 on the envelope E2 formed by the free ends 13b of the protuberances 13. The grooves provide additional storage for cosmetic products.

Thus, the user gains in ease and comfort of use. Indeed, regardless of the direction of rotation of the applicator 1 and/or the gesture of the user, the restitution and application alternate identically. In addition, the change in direction of winding 3 of the arms provides the applicator with a compromise between flexibility and rigidity.

Advantageously, the applicator 1 is a single monolithic piece obtained without assembly. In other words, the applicator 1 is not obtained by assembly.

Assembly is understood here as the fact of putting together, joining at least two isolated elements, but does not exclude the possibility of several steps.

It should also be noted that the applicator 1 advantageously forms a brush.

Preferably, the applicator 1 described above is obtained by an additive manufacturing method.

Additive manufacturing method means a manufacturing method by adding material, generally computer assisted. Such a manufacturing method is also referred to as three-dimensional printing or 3D printing.

Advantageously, the use of the three-dimensional printing can allow to produce in a single step an applicator 1 in a single piece and with continuity of material comprising at least two arms 3, at least one of which comprises at least two portions presenting a longitudinally winding of a different direction. Such an applicator 1 could be very complex or even impossible to obtain, in particular, in one piece, by a conventional injection moulding method. It is thus possible to produce the applicator 1 directly and in a single producing operation. In addition, this technique allows to eliminate the need for complex moulds.

Alternatively, three-dimensional printing can be used to form the core with the sleeve 5 and/or the stem 7.

Various additive manufacturing technologies known to the person skilled in the art can be used. In particular, this may include:
Fused deposition modelling (FDM),
Selective laser melting (SLM),
Selective laser sintering (SLS),
Electron beam melting (EBM),
Stereolithography Apparatus (SLA), or
Laminated object manufacturing (LOM).

Preferably, these are sintering and/or stereolithography technologies.

The invention further relates to a method for manufacturing an applicator 1 as described above. The method comprises:
a step of elaborating a digital model of the applicator 1;
a step of manufacturing the applicator 1 by means of the digital model.

The digital model is a computer file that corresponds to a virtual model of the applicator 1. To obtain this, the applicator 1 is first modelled so as to obtain a CAD model which is then converted into a suitable format such as an .STL file. The file is then processed on an additive manufacturing machine. When the digital model is read, it is divided into a number of layers depending on the desired accuracy. Preferably, the layers correspond to a cross-section of the applicator 1, i.e., a section of the applicator 1 taken in a plane perpendicular to the main axis X.

The suitable materials for manufacturing the applicator 1 using three-dimensional printing include polyamides, photosensitive resins, polylactic acid (PLA), acrylonitrile butadiene styrene (ABS), polypropylene (PP) and recycled polypropylene (R-PP).

The invention also relates to an applicator assembly 25 for a cosmetic product, comprising the container 21 comprising a body 27 forming a reservoir for containing the cosmetic product (not shown), and an applicator 1, as previously described, adapted to be fixed to the container 21, so that the applicator 1 is housed inside the container 21, i.e., the reservoir. The applicator 1 is attached, for example, to a proximal end of the stem 7, which is itself attached to a cap 29 advantageously screwed to the container 21.

Advantageously, the container comprises a wiper 31 fixed inside the container 21, in particular in the neck 19 or the opening orifice of the container 21.

Advantageously, the envelope E1, E2 of the applicator 1 formed by the free ends 13b of the protuberances 13 has a cross-section of circular general shape, the maximum diameter of which is substantially identical to the internal diameter of the wiper 31.

Passing the applicator 1 through the wiper 31 therefore allows to remove any excess cosmetic product and also to homogenise the distribution of the cosmetic product along the arms 3 because of their flexibility.

In addition, the formation of grooves 18 on the envelope E2 caused by the change in direction of the winding, in the case of an applicator 1 comprising protuberances 13, enables additional storage of cosmetic products.

Advantageously, the applicator assembly 25 may be obtained in whole or in part by three-dimensional printing.

1. An applicator for a cosmetic product comprising at least two arms extending along a main longitudinal axis of extension, referred to as the main axis (X), from a proximal end extended by a sleeve towards a free distal end opposite the proximal end, at least one of the arms comprises at least two portions (A, B, C), at least one of the portions (A, B, C) presenting a longitudinally winding of a different direction.

2. The applicator according to claim 1, wherein each of the arms comprises at least two portions (A, B, C) presenting a longitudinally winding of a different direction.

3. The applicator according to claim 1, wherein said at least one of the arms comprises at least three portions (A, B, C), each portion (A, B, C) presenting a longitudinally winding of a different direction from the adjacent portion (A, B, C).

4. The applicator according to claim 1, wherein the arms alternate angularly with openings defined between each of the arms and extend longitudinally.

5. The applicator according to claim 1, wherein said at least two arms define a cavity forming a reservoir volume.

6. The applicator according to claim 1, wherein said at least two arms wind parallel to one another about the main axis (X).

7. The applicator according to claim 1, wherein the arms have a flat internal surface directed towards the main axis (X).

8. The applicator according to claim 1, wherein each of said at least two arms comprises at least one longitudinal row (RI) of protuberances extending radially outwards from the arm, said longitudinal rows (RI) following the winding of the arm on which they are located.

9. The applicator according to claim 1, wherein each of said at least two arms comprises three longitudinal rows (RI) of protuberances extending radially outwards from the arm.

10. The applicator according to claim 8, wherein the protuberances comprise a planar upper face directed towards the distal end of the applicator and a planar lower face directed towards the proximal end, the upper face and the lower face extending from a base connected to the arm to an opposite free end, the free end being circular.

11. The applicator according to claim 10, wherein the circular free end of the protuberances is angularly offset with respect to the base.

12. The applicator according to claim 10, having an envelope (E1, E2) formed by the distal end of the protuberances, said envelope (E1, E2) having a cylindrical profile with a circular cross-section.

13. The applicator according to claim 1, wherein the applicator is a monolithic piece obtained without assembly and by additive manufacturing.

14. An applicator assembly for cosmetic product, comprising:
a container comprising a body forming a reservoir intended to contain the cosmetic product, and
an applicator of the cosmetic product according to claim 1 adapted to be attached to the container, so that the applicator is housed inside the reservoir.

15. A method for manufacturing an applicator for a cosmetic product according to claim 1, the method comprising:
a step of elaborating a digital model of the applicator;
a step of manufacturing the applicator by means of the digital model.
